(19) United States
(12) Patent Application Publication
(10) Pub. No.: US 2010/0236490 A1
(43) Pub. Date: Sep. 23, 2010

(54) VEHICLE FOR TRANSPORTING LIVESTOCK

(76) Inventor: Castane Basarana Sebastia, Barcelona (ES)

Correspondence Address: OSHA LIANG L.L.P., TWO HOUSTON CENTER, 909 FANNIN, SUITE 3500, HOUSTON, TX, 77010, US

(21) Appl. No.: 12/499,683

(22) Filed: Jul. 8, 2009

Related U.S. Application Data
(60) Provisional application No. 61/161,644, filed on Mar. 19, 2009.

(51) Int. Cl. B60P 3/04

(52) U.S. Cl. 119/407; 119/400; 119/408

(57) ABSTRACT

A vehicle for livestock transportation has a self-supporting structure that forms a load compartment delimited by two opposite lateral walls, a front frame, a rear frame, a lower base, a roof, and a lift platform with a load base joined to guide pillars by mobile pieces that slide alongside the guide pillars. The guide pillars are fixed onto the rear frame. The load base has the capacity to slide vertically alongside the guide pillars, keeping a horizontal position during movement, and tilt with respect to joint points located in the mobile pieces.

### FIELD OF THE INVENTION

The present invention relates to a vehicle for livestock transportation, specially designed to simplify and ease the load and unload operations, including at the same time a series of installations and control elements designed to preserve the well-being of the animals at all times.

### BACKGROUND OF THE INVENTION

During the load and unload of vehicles intended for livestock transportation, such as trailers, semi-trailers or tractor trailers, among others, there is more work performed by operators and it is one of the times when animals suffer from greater stress. Currently, there are different ways of loading and unloading these vehicles, although most of them turn out to be very inefficient, demanding great effort from the operators and resulting very uncomfortable for animals.

One of the more widely used methods consists of using a ramp located at the rear frame of the vehicle. This ramp allows the animals to overcome the difference in height between the ground surface and the lower base of the vehicle to access the load compartment. Quite often said compartment is vertically divided in one or more floors that define different height levels. Counting the lower base as the first level, the load compartment usually has a total of three or four height levels. In order to access the highest levels, it is necessary that the operators mount auxiliary interior ramps which communicate all floors. According to this load method, the operators start loading the upper floors, and at the same time they start removing the auxiliary ramps every time they complete a floor, until the lower base is loaded. The unload process is performed the other way round as previously described; that is to say, as the lower floors are emptied, auxiliary ramps are mounted until the upper floor is empty. This way of loading and unloading takes a lot of time and work for the operators. They have to relocate, mount and remove the auxiliary ramps manually in a given order. In turn, the animals suffer a great deal of physical weariness; due to the distance they have to cover until they reach their cells and also due to the fact that the ramps are very long and have a significant slope.

The load and unload moment is not the only one that causes considerable stress to animals. Transportation conditions also play a major role in this regard. Specifically, the thermal conditions of the interior of the load compartment have a direct influence on the well-being of animals.

### SUMMARY

According to one or more embodiments of the present invention, a vehicle comprises a lift platform with great versatility that enables operators to perform load and unload operations more efficiently. One or more embodiments of the present invention is complimented by a series of installations and control measures of the thermal conditions of the interior of the load compartment in order to guarantee and preserve the well-being of animals at all times, and reduce the mortality percentage of said animals during their transportation.

The vehicle for livestock transportation according to one or more embodiments of the present invention comprises a self-supporting structure that forms a load compartment delimited by two opposite lateral walls, a forward frame, a rear frame, a lower base and a roof, regardless of its size and the number of wheels shafts thereof.

The vehicle comprises a lift platform located at the rear frame. Said platform is constituted by a load base connected to some guide pillars by means of some mobile pieces that slide lengthwise said guides. The guide pillars are fixed onto the rear frame, one pillar on each vertical side of the rear frame. Preferably, each of the mobile pieces comprises a tubular element that slides inside the guide pillar and a bearing strip. The bearing strip is linked to the tubular element and it slides on the exterior of the guide pillar. The bearing strip serves as a support and fastening basis for the load base.

The load base has the capacity to slide vertically alongside the guide pillars, from the ground surface until the last load floor of the vehicle, keeping a horizontal position during its movement. The load base also has the capacity to tilt with respect to some joint points located on the mobile pieces until they are adjacent to the rear frame in vertical position. Likewise, the load base comprises some lateral handrails and at least one access door, defining a load area closed by all its flanks. The handrails, as well as the access doors, have the capacity to fold up over the load base, so that said load base can be adjacent to the rear frame. The load base can also be equipped with a weighing scale.

Preferably, the load base slides and tilts by means of hydraulic drives. The vertical movement is carried out thanks to a double-barrel hydraulic cylinder located in the interior of the tubular element, comprising two rods that slide in opposite ways. The lower rod end is anchored in the upper end of the tubular element. The hydraulic fluid is injected through the lower area of the guide pillar and flows inside the lower rod until it causes the elevation of the load base. The load base tilts thanks to the action of two hydraulic cylinders that are fed through another hydraulic circuit, anchored to the mobile piece and the load base. The control cabinet of the hydraulic system is located under the vehicle. The operators can activate the lift platform standing on top of it or out of it.

The procedure of loading and unloading the vehicle is remarkably simplified with respect to the known procedures. Specifically, the load and unload procedure according to one or more embodiments of the present invention is described as follows.

In order to load the vehicle, the load base of the lift platform is placed on the ground surface, while the lateral handrails and the access doors are unfolded. Lateral beams keep the handrails in upright position. Thus, a little corral is formed preventing animals from run away. The livestock can be loaded directly from the ground surface or directly from other vehicles. In the latter case, the only difference is that the load base is located at the same level as that in which the animals are in order to create a bridge. If necessary, during the load and unload operations, a ramp with a load base can also be created.

Once the animals are on the load base, said base elevates up to the first cargo level, that is to say, until it is even with the surface of the lower base of the vehicle. As previously mentioned, it is usual that the compartments have several floors in addition to the lower base. According to one or more embodiments of the present invention, these floors comprise a folding floor that widens the height for free circulation, greatly improving the work of the operators when transporting animals to their corresponding cells. This floor can be turned into one or more folding elements, according to the cell configuration per floor. Once the first level is completed, the folding floor of the next level is locked; the lift platform is loaded again and lifted until its load base evens the surface of the upper floor repeating the process. In order to ease the load of the last level, the roof of the vehicle is also folding. Preferably, the loading is performed successively from the first level to the last level, to ease the load operations for the workers. Nonetheless, this latter aspect is not an essential requirement since the different levels can be loaded in a random fashion, for example when said levels do not have a horizontal cell-like partition.

Finally, after loading the vehicle, the lateral handrails and the access doors are folded up onto the load base, placing it at the lower base level. Next, the load base is tilted until it is adjacent to the rear frame. As a safety measure during transportation, the vehicle according to one or more embodiments of the present invention employs one or more sensors that emit an alarm signal if the load base is not duly closed. Preferably, this alarm signal is monitored through GPS, although other visual or acoustic warning signals can be used.

The unload procedure is carried out in the same way but reversing the process. During the load and unload operations, a weighing control can be used if the load base is equipped with a weighing scale.

The load and unload procedure according to one or more embodiments of the present invention makes the job of the operators outstandingly easier, since they can freely circulate inside the load compartment without having to use auxiliary ramps. Likewise, the effort the animals make is also noticeably reduced and their physical weariness is avoided, since the path covered until reaching their cells is reduced and all slopes are eliminated.

The vehicle according to one or more embodiments of the present invention also includes a series of installations and control measures for the thermal conditions of the interior of the load compartment, with the purpose of guaranteeing and preserving the well-being of the animals during their transportation.

Specifically, the load compartment comprises a drinking facility connected to a water deposit so that the animals can drink during the transportation. The pipeline is mounted inside the compartment in such a way that all cells are supplied.

To keep good thermal conditions inside the load compartment, the vehicle according to one or more embodiments of the present invention also presents a sprinkler facility connected to a water deposit that makes it possible to hydrate the load compartment during the transportation.

Another measure to guarantee the thermal conditions consists in supplying the load compartment with good ventilation. In this regard, the lateral walls of the vehicle comprise several air vents between posts located alongside said lateral walls. The air vents are covered by electrically driven enclosures that slide between the posts to modify the useful ventilation surface.

The air vents are vertically interspersed with some blind panels fixed to the posts, preferably rectangular pillars with wings. These panels are double-wall panels with an intermediate air chamber to offer better thermal insulation. It is worth noticing that the roof is manufactured with insulating enclosures to also improve thermal insulation. The air vents can comprise one or more electric fans to generate a forced ventilation of the load compartment. The enclosures are joined to crossbars located on the upper sides of the lateral walls by slings. The crossbars rotate by the action of electric motors rolling up the slings upon themselves causing the enclosures to slide. Preferably, there is a crossbar per each lateral wall that slides all the enclosures on the same side simultaneously.

The aforementioned measures are complemented by a control system comprising one or more temperature and humidity sensors installed inside the load compartment which measure the thermal conditions thereof. The control system enables to monitor the thermal conditions inside the load compartment, adjust the position of the enclosures to increase or reduce the useful ventilation surface manually or automatically, activate or deactivate the fans manually or automatically, and activate or deactivate the sprinklers manually or automatically. Preferably, the control system is carried out through a GPS.

### BRIEF DESCRIPTION OF THE DRAWINGS

The following is a brief description of a series of drawings which will help understand the invention better and which clearly relate to an embodiment of said invention which is presented as a non-limiting example thereof.

FIG. 1 shows a side view of the vehicle according to one or more embodiments of the present invention.

FIG. 2 shows a section of the vehicle according to section plane I-I.

FIG. 3 shows a view of the inside of the guide pillar.

FIG. 4 shows a perspective view of the vehicle with the load base placed over the ground surface. Horizontal position.

FIG. 5 shows a perspective view of the vehicle with the load base placed over the ground surface. Ramp position.

FIG. 6 shows a perspective view of the vehicle with the load base levelled with the lower base.

FIG. 7 shows a perspective view of the vehicle with the load base levelled with the upper floor.

FIG. 8 shows a perspective view of the vehicle with the load base adjacent to the rear frame.

FIG. 9 shows a rear view of the vehicle.

FIG. 10 shows a section of the vehicle according to the section plane II-II.

FIG. 11 shows a partial view of the lateral wall with open air vents.

FIG. 12 shows a partial view of the lateral wall with closed air vents.

FIG. 13 shows a detailed view of FIG. 12 according to the section plane III-III.

### DETAILED DESCRIPTION

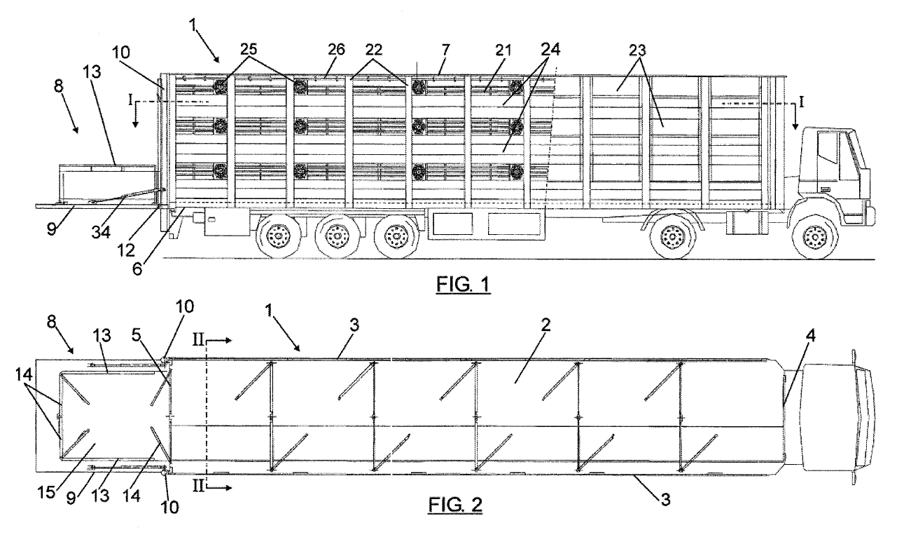

In FIGS. 1 and 2, it can be seen that the vehicle (1) for livestock transportation according to one or more embodiments of the present invention comprises a self-supporting structure which has a load compartment (2) delimited by two opposite lateral walls (3), a front frame (4), a rear frame (5), a lower base (6), and a roof (7).

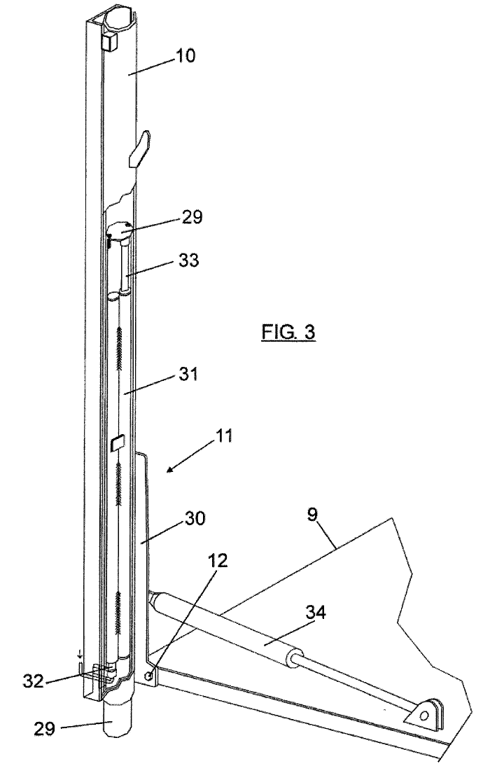

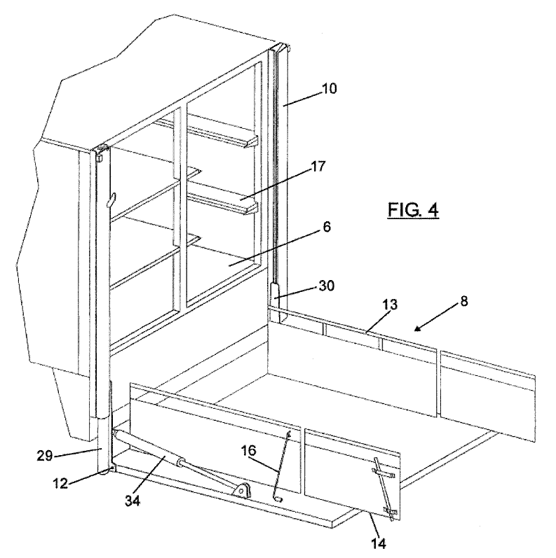

The vehicle (1) comprises a lift platform (8) located in the rear frame (5). Said platform (8) is formed by a load base (9) linked to guide pillars (10) by mobile pieces (11), FIG. 3, that slide along them. The guide pillars (10) are fixed over the rear frame (5), one pillar (10) on each vertical side of the rear frame (5).

The load base (9) has the capacity to move vertically alongside the guide pillars (10), from the ground surface until the last load floor (17) of the vehicle (1), keeping an upright position while moving. The load base (9) also has the capacity to tilt with respect to joint points (12) located in the mobile pieces (11) until it is adjacent to the rear frame (5) in upright position. Likewise, the load base (9) comprises some lateral handrails (13) and some access doors (14) that delimit a cargo space closed by all its flanks. The handrails (13) as well as the access doors (14) have the capacity to fold up over the load base (9), so that said base can be adjacent to the rear frame (5). The load base (9) can also be equipped with a weighing scale (15).

In FIG. 3, it can be seen that each one of the mobile pieces (11) comprises a tubular element (29) that slides inside the guide pillar (10) and a bearing strip (30). The bearing strip (30) is linked to the tubular element (29) and it slides along the exterior of the guide pillar. The bearing strip (30) serves as a support and fixing base for the load base (9). The load base (9) slides and tilts by way of hydraulic drives. The vertical movement is performed thanks to a double-barrel hydraulic cylinder (31) located inside the tubular body (29), which includes two rods that slide in opposite ways. The lower rod (32) end is anchored in the upper end of the tubular element (29). The hydraulic fluid is injected through the lower part of the guide pillar (10) and flows inside the lower rod (32) until it produces an elevation of the load base (9).

The load base (9) tilts thanks to the action of two hydraulic cylinders (34) anchored to the mobile piece (11) and to the load base (9) that are fed through another hydraulic circuit.

FIGS. 4, 5, 6, 7 and 8 show the different positions that the lift platform (8) can adopt during the vehicle (1) loading and unloading processes.

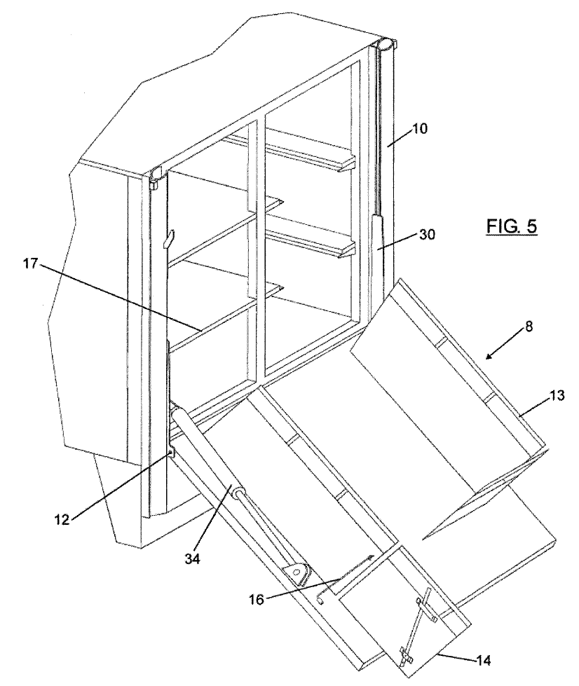

In order to load the vehicle (1), the load base (9) of the lift platform (8) is placed on the ground surface, while the lateral handrails (13) and the access doors (14), FIG. 4, unfold. Lateral beams (16) keep the handrails (13) in upright position. Thus, a small corral is formed preventing the animals from running away. If necessary, during the loading and unloading operations, a ramp with the load base (9), FIG. 5, can also be formed.

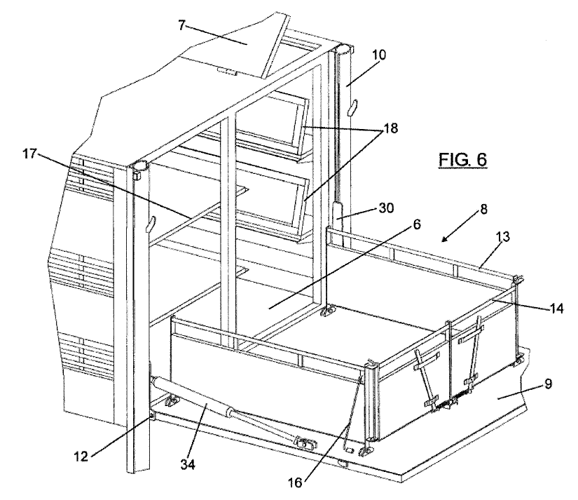

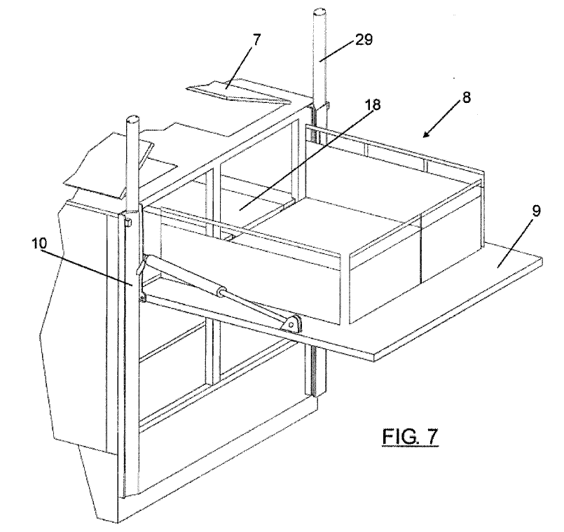

Once the animals are on the load base, said base elevates up to the first load level, that is to say, until it is even with the surface of the lower base (6) of the vehicle (1), FIG. 6. As previously mentioned, it is usual that the compartments have several floors (17) in addition to the lower base. These floors comprise a folding floor (18) that increases the height for free circulation. Once the first level is completed, the folding floor (18) of the floor (17) is locked, the lift platform (8) is loaded again and lifted until its load base (9) evens the surface of the upper floor (17), repeating the process. In order to ease the loading of the last level, the roof (7) of the vehicle (1) is also folding, FIG. 7.

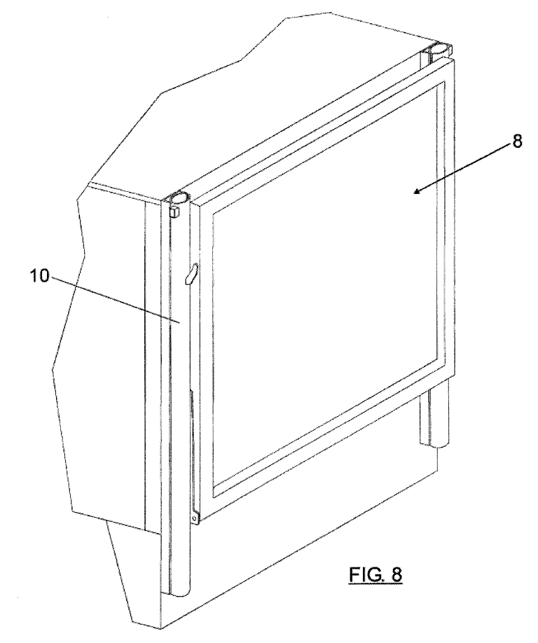

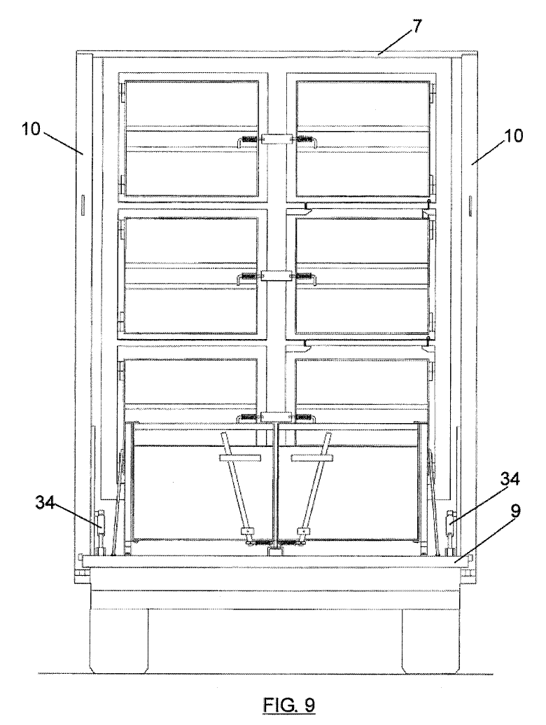

After loading the vehicle (1) the lateral handrails (13) and the access doors (14) fold up onto the load base (9) and said base is located at the level of the lower base (6). Next, the load base (9) tilts until it is adjacent to the rear frame (5), FIG. 8. FIG. 9 shows a rear view of the vehicle (1).

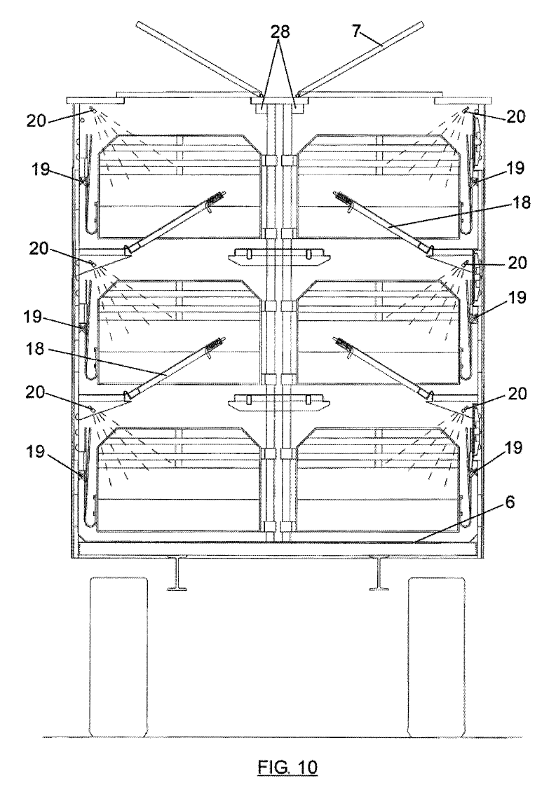

The vehicle (1) according to one or more embodiments of the present invention also comprises a series of installations and safety measures of the thermal conditions inside the load compartment (2), with the purpose of guaranteeing and preserving the well-being of animals during their transportation, FIGS. 10, 11, 12 and 13.

In FIG. 10, the load compartment (2) comprises a drinking facility (19) connected to a water deposit so that the animals can drink during the transportation.

In addition, it can be seen that the interior of the load compartment (2) also has sprinklers (20) connected to a water deposit that makes it possible to hydrate the load compartment during the transportation.

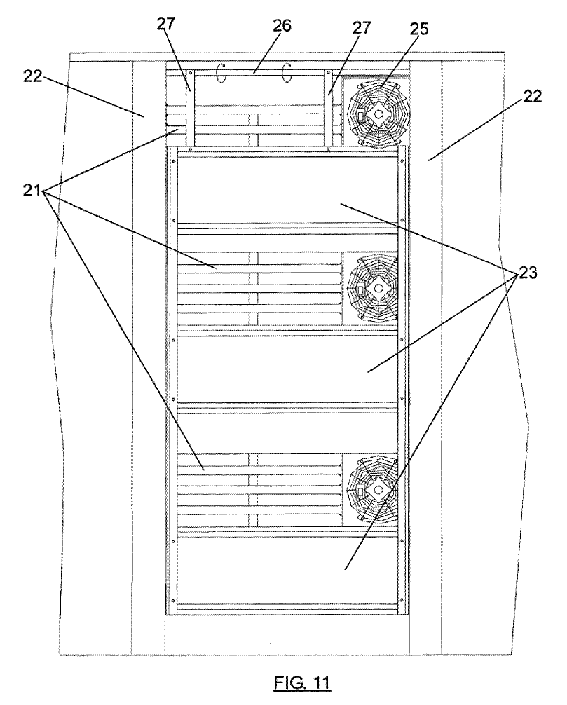

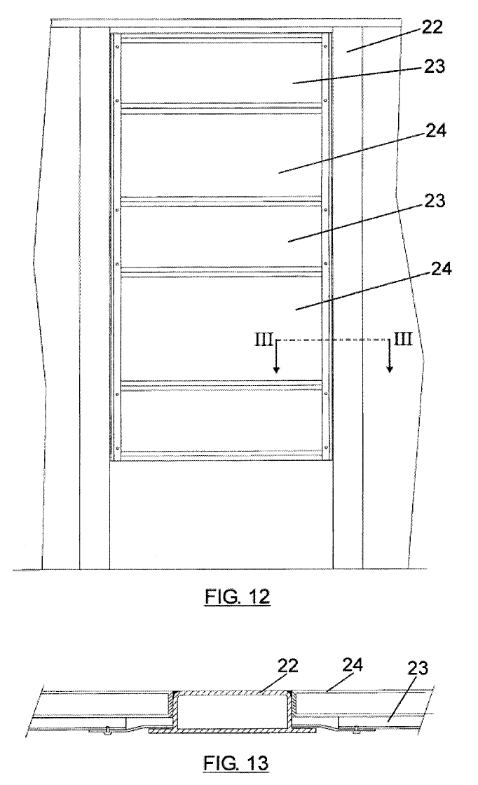

FIGS. 11 and 12 show the air vents (21) of the lateral walls (3), placed over posts (22) located alongside said lateral walls (3). The air vents (21) are covered by closures (23) electrically driven that slide between the posts (22) to modify the useful ventilation surface.

The air vents (21) are vertically interspersed with blind panels (24) fixed to the posts (22). These are double-wall panels (24) with an intermediate air chamber to offer better thermal insulation, FIG. 13. The air vents (21) can comprise one or more electric fans (25) to generate a forced ventilation of the cargo compartment. The enclosures (23) are joined to a crossbar (26) located on the upper part of the lateral walls (3) by slings (27). The crossbars (26) rotate by the action of electric motors rolling up the slings (27) upon themselves generating the movement of the enclosures (23).

The aforementioned measures are complemented by a control system comprising one or more temperature and humidity sensors (28) installed in the interior of the load compartment (2) that measure the thermal conditions thereof, FIG. 10.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A vehicle for livestock transportation comprising:
a self-supporting structure that forms a load compartment delimited by two opposite lateral walls,
a front frame,
a rear frame,
a lower base,
a roof, and
a lift platform with a load base joined to guide pillars by mobile pieces that slide alongside the guide pillars;
wherein said guide pillars are fixed onto the rear frame; and
wherein the load base has the capacity to:
slide vertically alongside the guide pillars, keeping a horizontal position during movement; and
tilt with respect to joint points located in the mobile pieces.

2. The vehicle for livestock transportation according to claim 1, wherein some of the mobile pieces comprises:
a tubular element that slides inside the guide pillar; and
a bearing strip linked to said tubular element that slides on the exterior of the guide pillar.

3. The vehicle for livestock transportation according to claim 1, wherein the vertical movement of the load base is performed by a double-barrel hydraulic cylinder located inside the mobile piece, comprising a lower rod and an upper rod that slide in opposite ways.

4. The vehicle for livestock transportation according to claim 1, wherein the load base tilts by hydraulic cylinders anchored to the mobile piece and to the load base.

5. The vehicle for livestock transportation according to claim 1, wherein the load base comprises:
lateral handrails and at least one access door that delimit a cargo space closed by all its flanks, and
which have the capacity to fold up onto the load base.

6. The vehicle for livestock transportation according to claim 1, wherein the load base comprises a weighing scale.

7. The vehicle for livestock transportation according to claim 1, wherein the load compartment is vertically divided in at least one floor with a folding floor that increases the height for free circulation inside the load compartment.

8. The vehicle for livestock transportation according to claim 1; the roof folds.

9. The vehicle for livestock transportation according to claim 1, wherein the load compartment comprises a drinking facility connected to a deposit.

10. The vehicle for livestock transportation according to claim 1, further comprising sprinklers connected to a deposit, which enable hydration of the load compartment.

11. The vehicle for livestock transportation according to claim 1, further comprising air vents located between posts alongside the lateral walls, covered by electrically driven enclosures that slide between the posts to modify the useful ventilation surface.

12. The vehicle for livestock transportation according to claim 11, wherein the air vents include at least one electric fan.

13. The vehicle for livestock transportation according to claim 10, further comprising a control system of thermal conditions inside the load compartment which enables:
monitoring the thermal conditions inside the load compartment;
adjusting the position of the enclosures to increase or reduce the useful ventilation surface manually or automatically,
activating or deactivating fans manually or automatically;
activating or deactivating the sprinklers manually or automatically.

14. The vehicle for livestock transportation according to claim 13, wherein the control system is carried out through a GPS.

15. The vehicle for livestock transportation according to claims 13, wherein the measurement of the thermal conditions is obtained by temperature and humidity sensors installed inside the load compartment.

16. A vehicle loading and unloading procedure for livestock transportation comprising:
loading the livestock onto a load base of a lift platform, directly from a ground surface or from another vehicle, having said load base in horizontal position, with the lateral handrails and access doors delimiting a closed space by all flanks;
lifting the load base while maintaining the horizontal position until reaching the desired floor of the load compartment and placing the livestock in their respective cells;
folding up the lateral handrails and access doors over the load base and locating said base at the same level of the lower base of the vehicle; and
tilting the load base until adjacent to the rear frame.

17. The vehicle loading and unloading procedure for livestock transportation according to claim 16 further comprising a weighing phase for both loading and unloading.

18. The vehicle for livestock transportation according to claim 12, further comprising a control system of thermal conditions inside the load compartment which enables:
monitoring the thermal conditions inside the load compartment;
adjusting the position of the enclosures to increase or reduce the useful ventilation surface manually or automatically,
activating or deactivating the fans manually or automatically;
activating or deactivating sprinklers manually or automatically.

19. The vehicle for livestock transportation according to claim 11, further comprising a control system of thermal conditions inside the load compartment which enables:
monitoring the thermal conditions inside the load compartment;
adjusting the position of the enclosures to increase or reduce the useful ventilation surface manually or automatically,
activating or deactivating fans manually or automatically;
activating or deactivating sprinklers manually or automatically.
